(19) United States
(12) Patent Application Publication
(10) Pub. No.: US 2025/0303367 A1
(43) Pub. Date: Oct. 2, 2025

(54) SEPARATION MEMBRANE COMPLEX AND METHOD OF PRODUCING SEPARATION MEMBRANE COMPLEX

(71) Applicant: NGK INSULATORS, LTD., Nagoya-City (JP)

(72) Inventors: Tomoyo AKAHIRA, Nagoya-Shi (JP); Makoto MIYAHARA, Tajimi-Shi (JP); Kenichi NODA, Nagoya-Shi (JP)

(73) Assignee: NGK INSULATORS, LTD., Nagoya-City (JP)

(21) Appl. No.: 19/238,762

(22) Filed: Jun. 16, 2025

Related U.S. Application Data
(63) Continuation of application No. PCT/JP2023/033801, filed on Sep. 15, 2023.

(30) Foreign Application Priority Data
Jan. 24, 2023 (JP) 2023-008625

(51) Int. Cl. B01D 69/12; B01D 53/02; B01D 67/00

(52) U.S. Cl. CPC B01D 69/12; B01D 53/02; B01D 67/00793; B01D 2253/204; B01D 2257/504

(57) ABSTRACT

A separation membrane complex includes a porous support and a separation membrane which is formed on the support and composed of metal organic framework MIL-96. In an X-ray diffraction pattern obtained by X-ray irradiation onto a surface of the separation membrane, an intensity of a peak existing in the vicinity of 2θ=5.6° is not higher than 0.15 times an intensity of a peak existing in the vicinity of 2θ=9.0° and not higher than 0.4 times an intensity of a peak existing in the vicinity of 2θ=16.6°.

### CROSS-REFERENCE TO RELATED APPLICATIONS

The present application is a continuation application of International Application No. PCT/JP2023/033801 filed on Sep. 15, 2023, which claims priority to Japanese Patent Application No. 2023-008625 filed on Jan. 24, 2023. The contents of these applications are incorporated herein by reference in their entirety.

### TECHNICAL FIELD

The present invention relates to a separation membrane complex and a method of producing a separation membrane complex.

### BACKGROUND ART

A metal organic framework (MOF) has a wide surface area and high adsorption performance, and study on the MOF as a material which is an alternative to a porous material such as zeolite or the like has been advanced. The MOF is ordinarily synthesized by causing an organic raw material and a metal source raw material to react with each other in water or an organic solvent. In order to form a MOF membrane on a porous support, the same synthesis method as that for a zeolite membrane is applicable, and a solvothermal method, including a hydrothermal synthesis method, can be used.

In the MOF membrane, the size of a pore diameter in a membrane surface is different, depending on a crystal plane for orientation. In a case where the MOF membrane is used as a separation membrane, it is important to form the MOF membrane so that target pores may be arranged on the surface. Even when the MOF membrane is synthesized on general conditions for the synthesis of MOF powder, however, an oriented MOF membrane cannot be obtained. For this reason, in order to orient the MOF membrane, a substance other than the raw material is added to a synthesis solution (synthetic sol). The synthesis of, for example, a MOF membrane known as MIL-96 (see “MIL-96, a Porous Aluminum Trimesate 3D Structure Constructed from a Hexagonal Network of 18-Membered Rings and μ₃-Oxo-Centered Trinuclear Units” by Thierry Loiseau and nine others (J. AM. CHEM. SOC., 2006, Vol. 128, pp. 10223 to 10230) (Document 1)) is disclosed in “Fabrication of MIL-96 nanosheets and relevant c-oriented ultrathin membrane through solvent optimization” by Sixing Chen and seven others (Journal of Membrane Science, 2022, Vol. 643, p. 120064) (Document 2), and by adding N-Methylformamide or formamide to the synthesis solution, a c-axis oriented or a- and b-axis-oriented MIL-96 membrane is synthesized on an a-alumina disc. The MIL-96 membrane has H₂ selectivity.

In recent years, required is a technique for separating and collecting CO₂ contained in an industrial exhaust gas or the like. For separation and collection of CO₂, high CO₂/N₂ separation performance is required, but there is no report of the MIL-96 membrane having high CO₂/N₂ separation performance.

### SUMMARY OF THE INVENTION

It is an object of the present invention to provide a separation membrane complex which has a separation membrane composed of metal organic framework MIL-96 and has high CO₂/N₂ separation performance.

A first aspect of the present invention is a separation membrane complex including a porous support and a separation membrane which is formed on the support and composed of metal organic framework MIL-96, in which in an X-ray diffraction pattern obtained by X-ray irradiation onto a surface of the separation membrane, an intensity of a peak existing in the vicinity of 2θ=5.6° is not higher than 0.15 times an intensity of a peak existing in the vicinity of 2θ=9.0° and not higher than 0.4 times an intensity of a peak existing in the vicinity of 2θ=16.6°.

According to the present invention, it is possible to provide a separation membrane complex which has a separation membrane composed of metal organic framework MIL-96 and has high CO₂/N₂ separation performance.

A second aspect of the present invention is the separation membrane complex of the first aspect, in which CO₂/N₂ ideal separation factor is not lower than 2.

A third aspect of the present invention is a method of producing a separation membrane complex including a) depositing seed crystals composed of metal organic framework MIL-96 onto a porous support, and b) forming a separation membrane on the support by immersing the support in a synthesis solution which contains an Al source and trimesic acid and has a pH of 1.90 to 2.51 and performing hydrothermal synthesis to grow metal organic framework MIL-96 from the seed crystals.

A fourth aspect of the present invention is the method of producing a separation membrane complex of the third aspect, in which an average particle diameter of the seed crystals is 180 to 220 nm.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a cross-sectional view of a separation membrane complex;

FIG. 2 is a cross-sectional view enlargedly showing part of the separation membrane complex;

FIG. 3 is a flowchart showing a flow for producing the separation membrane complex;

FIG. 4 is a view showing a separation apparatus; and

FIG. 5 is a flowchart showing a flow for separating a mixed substance by the separation apparatus.

### DETAILED DESCRIPTION

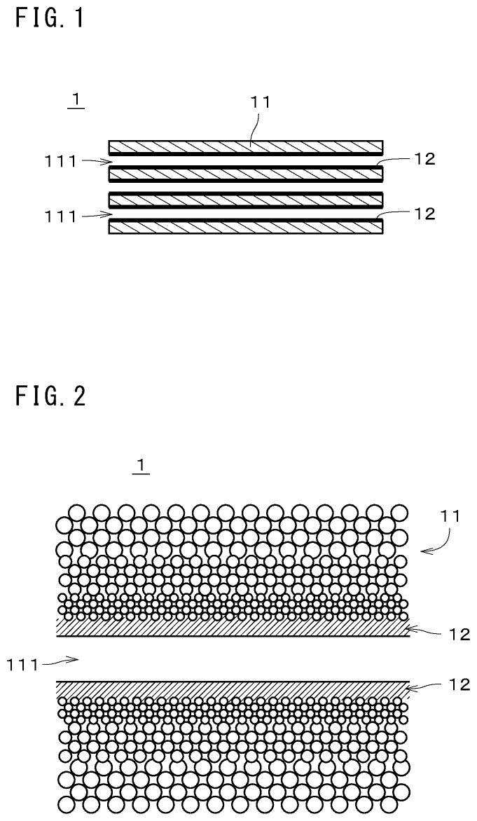

FIG. 1 is a cross-sectional view of a separation membrane complex 1, and FIG. 2 is a cross-sectional view enlargedly showing part of the separation membrane complex 1. The separation membrane complex 1 includes a porous support 11 and a separation membrane 12 formed on the support 11. As described later, the separation membrane 12 is a MOF membrane formed of metal organic framework (hereinafter, referred to as “MOF”), and the separation membrane complex 1 is a MOF membrane complex. The MOF membrane is at least obtained by forming MOF on a surface of the support 11 in a membrane form and does not include a membrane obtained by simply dispersing MOF particles in an organic membrane. In FIG. 1, the separation membrane 12 is represented by a thick line. In FIG. 2, the separation membrane 12 is hatched. Further, in FIG. 2, the thickness of the separation membrane 12 is shown larger than the actual one.

The support 11 is a porous member that gas and liquid can permeate. In the exemplary case shown in FIG. 1, the support 11 is a monolith-type support having an integrally and continuously molded columnar main body provided with a plurality of through holes 111 extending in a longitudinal direction (i.e., a left and right direction in FIG. 1). In the exemplary case shown in FIG. 1, the support 11 has a substantially columnar shape. A cross section perpendicular to the longitudinal direction of each of the through holes 111 (i.e., cells) is, for example, substantially circular. In FIG. 1, the diameter of each through hole 111 is larger than the actual diameter, and the number of through holes 111 is smaller than the actual number. The separation membrane 12 is formed on an inner surface of each through hole 111, covering substantially the entire inner surface of the through hole 111.

The length of the support 11 (i.e., the length in the left and right direction of FIG. 1) is, for example, 10 cm to 200 cm. The outer diameter of the support 11 is, for example, 0.5 cm to 30 cm. The distance between the central axes of adjacent through holes 111 is, for example, 0.3 mm to 10 mm. The surface roughness (Ra) of the support 11 is, for example, 0.1 μm to 5.0 μm, and preferably 0.2 μm to 2.0 μm. Further, the shape of the support 11 may be, for example, honeycomb-like, flat plate-like, tubular, cylindrical, columnar, polygonal prismatic, or the like. When the support 11 has a tubular or cylindrical shape, the thickness of the support 11 is, for example, 0.1 mm to 10 mm.

As the material for the support 11, various materials (for example, ceramics or a metal) can be adopted only if the materials ensure chemical stability in the process step of forming the separation membranes 12 on the surface thereof. In the present preferred embodiment, the support 11 is formed of a ceramic sintered body. Examples of the ceramic sintered body which is selected as a material for the support 11 include alumina, silica, mullite, zirconia, titania, yttria, silicon nitride, silicon carbide, and the like. In the present preferred embodiment, the support 11 contains at least one type of alumina, silica, and mullite.

The support 11 may contain an inorganic binder. As the inorganic binder, at least one of titania, mullite, easily sinterable alumina, silica, glass frit, a clay mineral, and easily sinterable cordierite can be used.

The average pore diameter of the support 11 is, for example, 0.01 μm to 70 μm, and preferably 0.05 μm to 25 μm. The average pore diameter of the support 11 in the vicinity of the surface on which the separation membrane 12 is formed is 0.01 μm to 1 μm, and preferably 0.05 μm to 0.5 μm. The average pore diameter can be measured by using, for example, a mercury porosimeter, a perm porometer, or a nano-perm porometer. Regarding the pore diameter distribution of the entire support 11 including the surface and the inside thereof, D5 is, for example, 0.01 μm to 50 μm, D50 is, for example, 0.05 μm to 70 μm, and D95 is, for example, 0.1 μm to 2000 μm. The porosity of the support 11 in the vicinity of the surface on which the separation membrane 12 is formed is, for example, 20% to 60%.

The support 11 has, for example, a multilayer structure in which a plurality of layers with different average pore diameters are layered in a thickness direction. The average pore diameter and the sintered particle diameter in a surface layer including the surface on which the separation membrane 12 is formed are smaller than those in layers other than the surface layer. The average pore diameter in the surface layer of the support 11 is, for example, 0.01 μm to 1 μm, and preferably 0.05 μm to 0.5 μm. When the support 11 has a multilayer structure, the materials for the respective layers can be those described above. The materials for the plurality of layers constituting the multilayer structure may be the same as or different from one another. Further, when the support 11 has a multilayer structure, the average pore diameter of the support 11 refers to the average pore diameter in the surface layer including the surface on which the separation membranes 12 is formed.

The separation membrane 12 is a MOF membrane, and is a porous membrane having micropores. The separation membrane 12 can separate a specific substance from a mixed substance in which a plurality of types of substances are mixed together, by using a molecular sieving function. As compared with the specific substance, any one of the other substances is harder to permeate the separation membrane 12. In other words, the permeance of any other substance through the separation membrane 12 is lower than that of the above-described specific substance.

The thickness of the separation membrane 12 is, for example, 0.05 μm to 30 μm, preferably 0.1 μm to 20 μm, and more preferably 0.5 μm to 10 μm. When the thickness of the separation membrane 12 is increased, the separation performance increases. When the thickness of the separation membrane 12 is reduced, the permeance increases. The surface roughness (Ra) of the separation membrane 12 is, for example, 5 μm or less, preferably 2 μm or less, more preferably 1 μm or less, and further preferably 0.5 μm or less.

The separation membrane 12 is composed of MOF known as MIL-96. In other words, the separation membrane 12 is a MIL-96 membrane. The separation membrane 12 is typically composed only of MIL-96, but depending on the production method or the like, any substance other than MIL-96 may be contained slightly (for example, 1 mass % or less) in the separation membrane 12. The pore diameter of MIL-96 is smaller than the average pore diameter of the support 11 in the vicinity of the surface on which the separation membrane 12 is formed.

MIL-96 contains an aluminum ion (Al³⁺) which is a metal ion and trimesic acid which is an organic ligand. Table 1 shows a diffraction angle (2θ) of a characteristic peak in an X-ray diffraction (XRD) pattern of typical MIL-96 powder, and in the MIL-96 membrane, the X-ray diffraction pattern obtained by X-ray irradiation onto a surface thereof includes at least one peak among the peaks shown in Table 1. The X-ray diffraction pattern is acquired by using a CuKα ray as a radiation source of an X-ray diffraction apparatus.

TABLE 1

| 2θ (degree) | (h k l) plane |
|---|---|
| 5.6 | 0 0 2 |
| 7.2 | 1 0 0 |
| 7.7 | 1 0 1 |
| 9.0 | 1 0 2 |
| 11.1 | 1 0 3 |
| 12.4 | 1 1 0 |
| 13.4 | 1 0 4 |
| 13.6 | 1 1 2 |
| 14.3 | 2 0 0 |
| 14.6 | 2 0 1 |
| 15.4 | 2 0 2 |
| 15.8 | 1 0 5 |
| 16.6 | 2 0 3 |
| 16.8 | 1 1 4 |
| 18.2 | 2 0 4 |
| 18.4 | 1 0 6 |
| 19.1 | 2 1 0 |
| 19.8 | 2 1 2 |
| 20.8 | 2 1 3 |
| 21.7 | 3 0 0 |
| 22.2 | 2 1 4 |
| 22.7 | 0 0 8 |
| 23.2 | 3 0 3 |
| 23.7 | 2 1 5 |
| 24.4 | 3 0 4 |
| 25.1 | 2 2 0 |
| 25.6 | 2 1 6 |
| 26.0 | 1 1 8 |
| 26.7 | 1 0 9 |
| 27.0 | 2 0 8 |
| 27.5 | 3 1 3 |
| 28.5 | 3 1 4 |
| 29.0 | 4 0 0 |
| 29.5 | 1 0 10 |
| 29.8 | 2 1 8 |
| 30.3 | 4 0 3 |
| 31.2 | 4 0 4 |
| 31.6 | 3 0 8 |
| 32.2 | 2 0 10 |
| 32.8 | 3 2 3 |
| 33.4 | 4 1 0 |
| 33.7 | 3 2 4 |
| 34.4 | 0 0 12 |
| 34.9 | 3 2 5 |
| 35.2 | 1 0 12 |
| 36.2 | 3 0 10 |
| 36.4 | 5 0 0 |
| 36.9 | 3 1 9 |
| 37.5 | 2 0 12 |
| 38.0 | 3 3 0 |
| 38.4 | 2 2 10 |
| 38.8 | 4 2 1 |
| 39.3 | 5 0 5 |
| 39.7 | 4 2 3 |

In the separation membrane 12 of the present preferred embodiment, in the X-ray diffraction pattern obtained by X-ray irradiation onto the surface thereof, an intensity of a peak existing in the vicinity of 2θ=5.6° is not lower than 0 times and not higher than 0.15 times an intensity of a peak existing in the vicinity of 2θ=9.0°. Further, the intensity of the peak existing in the vicinity of 2θ=5.6° is not lower than 0 times and not higher than 0.4 times an intensity of a peak existing in the vicinity of 2θ=16.6°. The peak existing in the vicinity of 2θ=5.6° is a peak existing in a range of 2θ=5.6°±0.4° and is derived from a (002) plane of MIL-96. The peak existing in the vicinity of 2θ=9.0° is a peak existing in a range of 2θ=9.0°±0.4° and is derived from a (102) plane of MIL-96. The peak existing in the vicinity of 2θ=16.6° is a peak existing in a range of 2θ=16.6°±0.4° and is derived from a (203) plane of MIL-96. In the typical separation membrane 12, the peak intensity in the vicinity of 2θ=5.6°, the peak intensity in the vicinity of 2θ=9.0°, and the peak intensity in the vicinity of 2θ=16.6° are each larger than 0. The peak intensity in the vicinity of 2θ=5.6° may be 0. Further, it is assumed that the peak intensity uses a height of the X-ray diffraction pattern except a bottom line thereof, i.e., a background noise component. The bottom line of the X-ray diffraction pattern can be obtained, for example, by the Sonneveld-Visser method or a spline interpolation method.

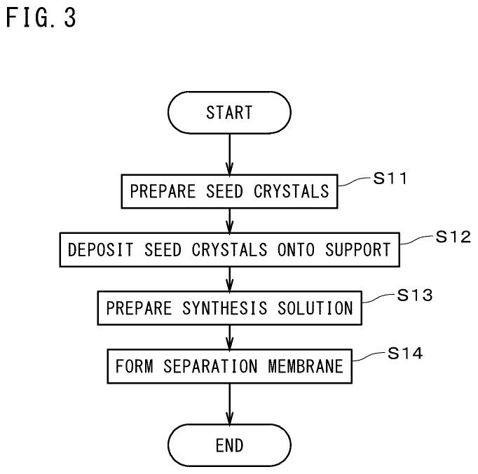

FIG. 3 of “Fabrication of MIL-96 nanosheets and relevant c-oriented ultrathin membrane through solvent optimization” by Sixing Chen and seven others (Journal of Membrane Science, 2022, Vol. 643, p. 120064) (above-described Document 2), for example, shows the X-ray diffraction pattern of the c-axis oriented MIL-96 membrane. In this X-ray diffraction pattern, the intensity of the peak existing in the vicinity of 2θ=5.6° is higher than 0.15 times the intensity of the peak existing in the vicinity of 2θ=9.0° and higher than 0.4 times the intensity of the peak existing in the vicinity of 2θ=16.6°. In the MIL-96 membrane, the (002) plane is oriented to a front surface thereof. Since the pore diameter in the (002) plane is small, CO₂ gas is hard to permeate the MIL-96 membrane. Document 2 also shows the X-ray diffraction pattern of the a- and b-axis-oriented MIL-96 membrane, and also in this X-ray diffraction pattern, the intensity of the peak existing in the vicinity of 2θ=5.6° is higher than 0.15 times the intensity of the peak existing in the vicinity of 2θ=9.0° and higher than 0.4 times the intensity of the peak existing in the vicinity of 2θ=16.6°. Therefore, CO₂ gas is hard to permeate the a- and b-axis-oriented MIL-96 membrane, like the c-axis oriented MIL-96 membrane.

In contrast to this, in the separation membrane 12 in which the intensity of the peak existing in the vicinity of 2θ=5.6° is not higher than 0.15 times the intensity of the peak existing in the vicinity of 2θ=9.0° and not higher than 0.4 times the intensity of the peak existing in the vicinity of 2θ=16.6°, the (002) plane is not oriented to a front surface thereof (specifically, a plane other than the c-axis is oriented). In other words, the separation membrane 12 is a MIL-96 membrane in which a plane whose pore diameter is relatively larger than that of the (002) plane is positioned to the front surface, and CO₂ gas becomes easy to permeate the membrane. As a result, as described later, the CO₂/N₂ separation performance in the separation membrane 12 becomes higher.

In the separation membrane 12, in order to surely increase the CO₂/N₂ separation performance, the intensity of the peak existing in the vicinity of 2θ=5.6° is preferably not higher than 0.12 times the intensity of the peak existing in the vicinity of 2θ=9.0°, and more preferably not higher than 0.10 times. Similarly, the intensity of the peak existing in the vicinity of 2θ=5.6° is preferably not higher than 0.35 times the intensity of the peak existing in the vicinity of 2θ=16.6°, and more preferably not higher than 0.30 times.

Next, with reference to FIG. 3, an exemplary flow of producing the separation membrane complex 1 will be described. In production of the separation membrane complex 1, first, seed crystals to be used for production of the separation membrane 12 are prepared (Step S11). As to the seed crystals, for example, MIL-96 powder is synthesized by hydrothermal synthesis (solvothermal method), and the seed crystals are acquired from the MIL-96 powder. The MIL-96 powder may be synthesized by any or well-known production method. The MIL-96 powder itself may be used as the seed crystals, or may be processed by pulverization or the like, to thereby acquire the seed crystals. The average particle diameter (D50) of the seed crystals is preferably 180 to 220 nm (about 200 nm). In this case, as to the particle size distribution of the seed crystals, D10 is, for example, 50 to 200 nm, and D90 is, for example, 200 to 600 nm. By adopting the average particle diameter not smaller than 180 nm, it is possible to suppress deterioration of the crystallinity of the seed crystals. Further, by adopting the average particle diameter not larger than 220 nm, the specific surface area can be made larger, and therefore the seed crystals having many active surfaces can be obtained. For this reason, by using the seed crystals having an average particle diameter of 180 to 220 nm, in the later-described process of forming the separation membrane 12, it becomes possible to form the separation membrane 12 at relatively low synthesis temperature. The average particle diameter of the seed crystals can be measured by, for example, a laser scattering method.

Further, it is preferable that the average particle diameter of the seed crystals should be 1.1 to 2.5 times the average pore diameter of the support 11. By adopting the average particle diameter of the seed crystals not smaller than 1.1 times the average pore diameter of the support 11, it becomes possible to efficiently arrange the seed crystals on the support 11. By adopting the average particle diameter of the seed crystals not larger than 2.5 times the average pore diameter of the support 11, it becomes possible to narrow a gap between the seed crystals and densify the separation membrane 12 in a short time.

Subsequently, the porous support 11 is immersed in a dispersion liquid in which the seed crystals are dispersed, and the seed crystals are thereby deposited onto the support 11 (Step S12). Alternatively, the dispersion liquid in which the seed crystals are dispersed is brought into contact with a portion on the support 11 where the separation membrane 12 is to be formed, and the seed crystals are thereby deposited onto the support 11. A support with seed crystals deposited thereon is thereby produced. The seed crystals may be deposited onto the support 11 by any other method.

Further, a synthesis solution (also referred to as a synthetic sol or a starting material solution) to be used for forming the separation membrane 12 is prepared (Step S13). The synthesis solution is produced by mixing, for example, an Al source and trimesic acid into water and stirring the mixture while heating it. The Al source is, for example, aluminium nitrate nonahydrate, aluminium chloride hexahydrate, aluminium sulfate 14-18 water, aluminum hydroxide, or the like. The pH (hydrogen ion exponent) of the synthesis solution is 1.90 to 2.51. Only if the pH of the synthesis solution keeps within the above-described range, any other substance may be mixed into the synthesis solution.

After the synthesis solution is prepared, the support 11 on which the seed crystals are deposited is immersed in the synthesis solution. After that, by heating the synthesis solution, the hydrothermal synthesis is started. In the hydrothermal synthesis, the MIL-96 is caused to grow from the seed crystals as nuclei, to thereby form the separation membrane 12 which is the dense MIL-96 membrane on the support 11 (Step S14). The synthesis temperature (the heating temperature of the synthesis solution) in the hydrothermal synthesis is, for example, 100° C. to 200° C., and preferably 120° C. to 180° C. The hydrothermal synthesis time is, for example, 3 to 48 hours, and preferably 3 to 24 hours.

After the hydrothermal synthesis is finished, the support 11 and the separation membrane 12 are washed with pure water and then washed with ethanol or the like. Preferably, the support 11 and the separation membrane 12 are immersed and heated in high-temperature water (for example, 100° C.), to be thereby further washed. After washing, the support 11 and the separation membrane 12 are dried, for example, at 100° C. By the above process, the above-described separation membrane complex 1 is obtained.

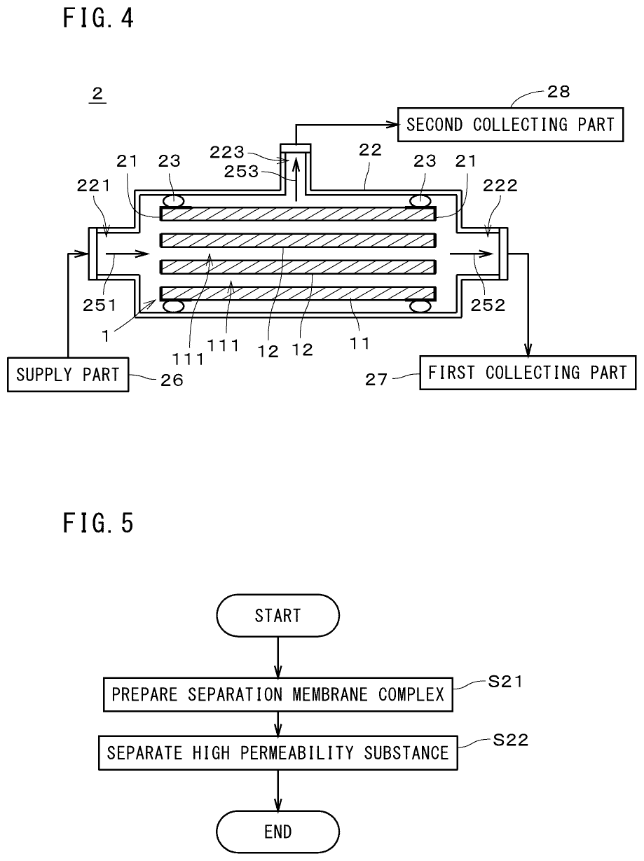

Next, with reference to FIGS. 4 and 5, separation of a mixed substance by using the separation membrane complex 1 will be described. FIG. 4 is a view showing a separation apparatus 2. FIG. 5 is a flowchart showing a flow of separating the mixed substance by the separation apparatus 2.

In the separation apparatus 2, a mixed substance containing a plurality of types of fluids (i.e., gases or liquids) is supplied to the separation membrane complex 1, and a substance with high permeability in the mixed substance is caused to permeate the separation membrane complex 1, to be thereby separated from the mixed substance. Separation in the separation apparatus 2 may be performed, for example, in order to extract a substance with high permeability from a mixed substance, or in order to concentrate a substance with low permeability.

The mixed substance (i.e., mixed fluid) may be a mixed gas containing a plurality of types of gases, may be a mixed liquid containing a plurality of types of liquids, or may be a gas-liquid two-phase fluid containing both a gas and a liquid.

The mixed substance contains at least one type of, for example, hydrogen (H₂), helium (He), nitrogen (N₂), oxygen (O₂), water (H₂O), carbon monoxide (CO), carbon dioxide (CO₂), nitrogen oxide, ammonia (NH₃), sulfur oxide, hydrogen sulfide (H₂S), sulfur fluoride, mercury (Hg), arsine (AsH₃), hydrogen cyanide (HCN), carbonyl sulfide (COS), C1 to C8 hydrocarbons, organic acid, alcohol, mercaptans, ester, ether, ketone, and aldehyde.

The nitrogen oxide is a compound of nitrogen and oxygen. The above-described nitrogen oxide is, for example, a gas called NOₓ such as nitric oxide (NO), nitrogen dioxide (NO₂), nitrous oxide (also referred to as dinitrogen monoxide) (N₂O), dinitrogen trioxide (N₂O₃), dinitrogen tetroxide (N₂O₄), dinitrogen pentoxide (N₂O₅), or the like.

The sulfur oxide is a compound of sulfur and oxygen. The above-described sulfur oxide is, for example, a gas called SOₓ such as sulfur dioxide (SO₂), sulfur trioxide (SO₃), or the like.

The sulfur fluoride is a compound of fluorine and sulfur. The above-described sulfur fluoride is, for example, disulfur difluoride (F—S—S—F, S═SF₂), sulfur difluoride (SF₂), sulfur tetrafluoride (SF₄), sulfur hexafluoride (SF₆), disulfur decafluoride (S₂F₁₀), or the like.

The C1 to C8 hydrocarbons are hydrocarbons with not less than 1 and not more than 8 carbon atoms. The C3 to C8 hydrocarbons may be any one of a linear-chain compound, a side-chain compound, and a ring compound. Further, the C2 to C8 hydrocarbons may either be a saturated hydrocarbon (i.e., in which there is no double bond or triple bond in a molecule), or an unsaturated hydrocarbon (i.e., in which there is a double bond and/or a triple bond in a molecule). The C1 to C4 hydrocarbons are, for example, methane (CH₄), ethane (C₂H₆), ethylene (C₂H₄), propane (C₃H₈), propylene (C₃H₆), normal butane (CH₃(CH₂)₂CH₃), isobutane (CH (CH₃)₃), 1-butene (CH₂═CHCH₂CH₃), 2-butene (CH₃CH═CHCH₃), or isobutene (CH₂═C(CH₃)₂).

The above-described organic acid is carboxylic acid, sulfonic acid, or the like. The carboxylic acid is, for example, formic acid (CH₂O₂), acetic acid (C₂H₄O₂), oxalic acid (C₂H₂O₄), acrylic acid (C₃H₄O₂), benzoic acid (C₆H₅COOH), or the like. The sulfonic acid is, for example, ethanesulfonic acid (C₂H₆O₃S) or the like. The organic acid may either be a chain compound or a ring compound.

The above-described alcohol is, for example, methanol (CH₃OH), ethanol (C₂H₅OH), isopropanol (2-propanol) (CH₃CH(OH)CH₃), ethylene glycol (CH₂(OH)CH₂(OH)), butanol (C₄H₉OH), or the like.

The mercaptans are an organic compound having hydrogenated sulfur (SH) at the terminal end thereof, and are a substance also referred to as thiol or thioalcohol. The above-described mercaptans are, for example, methyl mercaptan (CH₃SH), ethyl mercaptan (C₂H₅SH), 1-propanethiol (C₃H₇SH), or the like.

The above-described ester is, for example, formic acid ester, acetic acid ester, or the like.

The above-described ether is, for example, dimethyl ether ((CH₃)₂O), methyl ethyl ether (C₂H₅OCH₃), diethyl ether ((C₂H₅)₂O), or the like.

The above-described ketone is, for example, acetone ((CH₃)₂CO), methyl ethyl ketone (C₂H₅COCH₃), diethyl ketone ((C₂H₅)₂CO), or the like.

The above-described aldehyde is, for example, acetaldehyde (CH₃CHO), propionaldehyde (C₂H₅CHO), butanal (butylaldehyde) (C₃H₇CHO), or the like.

In the following description, it is assumed that the mixed substance to be separated by the separation apparatus 2 is a mixed gas containing a plurality of types of gases.

The separation apparatus 2 includes the separation membrane complex 1, sealing parts 21, a housing 22, two sealing members 23, a supply part 26, a first collecting part 27, and a second collecting part 28. The separation membrane complex 1, the sealing parts 21, and the sealing members 23 are accommodated inside the housing 22. The supply part 26, the first collecting part 27, and the second collecting part 28 are disposed outside the housing 22 and connected to the housing 22.

The sealing parts 21 are members which are attached to both end portions in the longitudinal direction (i.e., in the left and right direction of FIG. 4) of the support 11 and cover and seal both end surfaces in the longitudinal direction of the support 11 and outer surfaces in the vicinity of the end surfaces. The sealing parts 21 prevent a gas from flowing into or out from both the end surfaces of the support 11. The sealing part 21 is, for example, a plate-like member formed of glass or a resin. The material and the shape of the sealing part 21 may be changed as appropriate. Further, since the sealing part 21 is provided with a plurality of openings which coincide with the plurality of through holes 111 of the support 11, both ends of each through hole 111 of the support 11 in the longitudinal direction are not covered with the sealing parts 21. Therefore, the gas or the like can flow into and out from the through hole 111 from both ends thereof.

There is no particular limitation on the shape of the housing 22 but is, for example, a tubular member having a substantially cylindrical shape. The housing 22 is formed of, for example, stainless steel or carbon steel. The longitudinal direction of the housing 22 is substantially in parallel to the longitudinal direction of the separation membrane complex 1. A supply port 221 is provided at an end portion on one side in the longitudinal direction of the housing 22 (i.e., an end portion on the left side in FIG. 4), and a first exhaust port 222 is provided at another end portion on the other side. A second exhaust port 223 is provided on a side surface of the housing 22. The supply part 26 is connected to the supply port 221. The first collecting part 27 is connected to the first exhaust port 222. The second collecting part 28 is connected to the second exhaust port 223. An internal space of the housing 22 is a sealed space that is isolated from the space around the housing 22.

The two sealing members 23 are arranged around the entire circumference between an outer surface of the separation membrane complex 1 and an inner surface of the housing 22 in the vicinity of both end portions of the separation membrane complex 1 in the longitudinal direction. Each of the sealing members 23 is a substantially annular member formed of a material that the gas cannot permeate. The sealing member 23 is, for example, an O-ring formed of a flexible resin. The sealing members 23 come into close contact with the outer surface of the separation membrane complex 1 and the inner surface of the housing 22 around the entire circumferences thereof. In the exemplary case of FIG. 4, the sealing members 23 come into close contact with outer surfaces of the sealing parts 21 and indirectly come into close contact with the outer surface of the separation membrane complex 1 with the sealing parts 21 interposed therebetween. The portions between the sealing members 23 and the outer surface of the separation membrane complex 1 and between the sealing members 23 and the inner surface of the housing 22 are sealed, and it is thereby mostly or completely impossible for the gas to pass through the portions.

The supply part 26 supplies the mixed gas into the internal space of the housing 22 through the supply port 221. The supply part 26 includes, for example, a blower or a pump for pumping the mixed gas toward the housing 22. The blower or the pump includes a pressure regulating part for regulating the pressure of the mixed gas to be supplied to the housing 22. The first collecting part 27 and the second collecting part 28 each include, for example, a storage container for storing the gas led out from the housing 22 or a blower or a pump for transporting the gas.

When separation of the mixed gas is performed, the above-described separation apparatus 2 is prepared and the separation membrane complex 1 is thereby prepared (Step S21). Subsequently, the supply part 26 supplies a mixed gas containing a plurality of types of gases with different permeabilities for the separation membrane 12 into the internal space of the housing 22. For example, the main component of the mixed gas includes CO₂ and N₂. The mixed gas may contain any gas other than CO₂ or N₂. The pressure (i.e., feed pressure) of the mixed gas to be supplied into the internal space of the housing 22 from the supply part 26 is, for example, 0.1 MPa to 20.0 MPa. The temperature for separation of the mixed gas is, for example, 10° C. to 150° C.

The mixed gas supplied from the supply part 26 into the housing 22 is fed from the left end of the separation membrane complex 1 in this figure into the inside of each through hole 111 of the support 11 as indicated by an arrow 251. Gas with high permeability (which is, for example, CO₂, and hereinafter is referred to as a “high permeability substance”) in the mixed gas permeates the separation membrane 12 formed on the inner surface of each through hole 111 and the support 11, and is led out from the outer surface of the support 11. The high permeability substance is thereby separated from gas with low permeability (which is, for example, N₂, and hereinafter is referred to as a “low permeability substance”) in the mixed gas (Step S22). The gas (hereinafter, referred to as a “permeate substance”) led out from the outer surface of the support 11 is collected by the second collecting part 28 through the second exhaust port 223 as indicated by an arrow 253. The pressure (i.e., permeate pressure) of the gas to be collected by the second collecting part 28 through the second exhaust port 223 is, for example, about 1 atmospheric pressure (0.101 MPa).

Further, in the mixed gas, a gas (hereinafter, referred to as a “non-permeate substance”) other than the gas which has permeated the separation membrane 12 and the support 11 passes through each through hole 111 of the support 11 from the left side to the right side in this figure and is collected by the first collecting part 27 through the first exhaust port 222 as indicated by an arrow 252. The pressure of the gas to be collected by the first collecting part 27 through the first exhaust port 222 is, for example, substantially the same as the feed pressure. The non-permeate substance may include a high permeability substance that has not permeated the separation membrane 12, as well as the above-described low permeability substance.

Next, Examples 1 to 10 and Comparative Examples 1 to 3 of the separation membrane complex will be described. Table 2 shows the pH of the synthesis solution used for formation of the MIL-96 membrane, and the synthesis temperature and the synthesis time of the MIL-96 membrane. Further, in the X-ray diffraction pattern described later, a ratio of the peak intensity in the vicinity of 2θ=5.6° to the peak intensity in the vicinity of 2θ=9.0° is represented as a “peak intensity ratio of 5.6°/9.0°”, and a ratio of the peak intensity in the vicinity of 2θ=5.6° to the peak intensity in the vicinity of 2θ=16.6° is represented as a “peak intensity ratio of 5.6°/16.6°”.

TABLE 2

| | Synthesis | Synthesis | Synthesis | Peak Intensity | Peak Intensity |
|---|---|---|---|---|---|
| | Solution | Temperature | Time | Ratio of | Ratio of |
| | pH | [° C.] | [h] | 5.6°/9.0° | 5.6°/16.6° |
| Example 1 | 1.90 | 180 | 6 | 0.07 | 0.22 |
| Example 2 | 1.90 | 180 | 3 | 0.09 | 0.33 |
| Example 3 | 1.90 | 160 | 6 | 0.05 | 0.18 |
| Example 4 | 2.24 | 180 | 6 | 0.08 | 0.19 |
| Example 5 | 2.51 | 180 | 6 | 0.05 | 0.17 |
| Example 6 | 2.24 | 160 | 6 | 0.06 | 0.21 |
| Example 7 | 2.24 | 140 | 6 | 0.08 | 0.25 |
| Example 8 | 2.42 | 160 | 6 | 0.06 | 0.20 |
| Example 9 | 2.42 | 140 | 6 | 0.08 | 0.21 |
| Example 10 | 2.51 | 120 | 24 | 0.09 | 0.24 |
| Comparative | 1.74 | 210 | 2 | 21.1 | 32.9 |
| Example 1 | | | | | |
| Comparative | 1.74 | 210 | 2 | 1.87 | 2.64 |
| Example 2 | | | | | |
| Comparative | 1.80 | 180 | 6 | 0.08 | 0.17 |
| Example 3 | | | | | |

### <Production of Separation Membrane Complex>

### Example 1

### [Synthesis of Seed Crystals]

Aluminium nitrate nonahydrate and trimesic acid are dissolved in a solution in which water (ion exchange water) and N,N-dimethylformamide are mixed at 1:1 (volume ratio). Subsequently, acetic acid is added to the solution and the solution is heated. After heating, a product is separated from the solution by centrifugal separation and washed with water and ethanol in this order, to thereby obtain the seed crystals. The average particle diameter of the seed crystals is within a range from 180 to 220 nm.

### [Seeding]

The seed crystals obtained as above are applied to an alumina support. The alumina support having an average pore diameter of about 100 nm is used.

### [Membrane Formation]

As the synthesis solution (synthetic sol) for membrane formation, aluminium nitrate nonahydrate, trimesic acid, and water are mixed at a molar ratio of 3.5:1:2952, and the solution is stirred while being heated until the solution becomes transparent. The support to which the seed crystals are applied and the obtained synthesis solution are put into a Teflon (registered trademark) container and heated at 180° C. for six hours, to thereby form (synthesize) the MIL-96 membrane thereon. Subsequently, the support is washed with water and ethanol in this order at room temperature, and then immersed and heated in water at 100° C. for one night to be additionally washed. After cooling, the support is taken out and dried with a dryer at 100° C. for three hours, to thereby obtain the separation membrane complex.

### Example 2

Example 2 is the same as Example 1 except that the synthesis time in the membrane formation is changed to three hours.

### Example 3

Example 3 is the same as Example 1 except that the synthesis temperature in the membrane formation is changed to 160° C.

### Example 4

Example 4 is the same as Example 1 except that the composition of the synthesis solution for membrane formation is changed to aluminium nitrate nonahydrate:trimesic acid:water=3.5:1:5900 (at a molar ratio, the same applies to the following).

### Example 5

Example 5 is the same as Example 1 except that the composition of the synthesis solution for membrane formation is changed to aluminium nitrate nonahydrate:trimesic acid:water=3.5:1:14760.

### Example 6

Example 6 is the same as Example 4 except that the synthesis temperature in the membrane formation is changed to 160° C.

### Example 7

Example 7 is the same as Example 4 except that the synthesis temperature in the membrane formation is changed to 140° C.

### Example 8

Example 8 is the same as Example 5 except that the composition of the synthesis solution for membrane formation is changed to aluminium nitrate nonahydrate:trimesic acid:water=3.5:1:8850 and the synthesis temperature in the membrane formation is changed to 160° C.

### Example 9

Example 9 is the same as Example 5 except that the composition of the synthesis solution for membrane formation is changed to aluminium nitrate nonahydrate:trimesic acid:water=3.5:1:8850 and the synthesis temperature in the membrane formation is changed to 140° C.

### Example 10

Example 10 is the same as Example 5 except that the synthesis temperature in the membrane formation is changed to 120° C. and the synthesis time is changed to twenty four hours.

### Comparative Example 1

Comparative Example 1 is the same as Example 1 in the synthesis of the seed crystals and the seeding.

### [Membrane Formation]

The synthesis solution for membrane formation is prepared by mixing aluminium nitrate nonahydrate, trimesic acid, water, N-Methylformamide, and acetic acid at a molar ratio of 1:1:700:170:2.4. The support to which the seed crystals are applied and the obtained synthesis solution are put into the Teflon container and heated at 210° C. for two hours, to thereby form the MIL-96 membrane thereon. After that, the support is washed with water and ethanol in this order and dried with the dryer at 70° C. for one night, to thereby obtain the separation membrane complex.

### Comparative Example 2

Comparative Example 2 is the same as Comparative Example 1 except that in the preparation of the synthesis solution for membrane formation, N-Methylformamide is changed to formamide, to thereby form the MIL-96 membrane.

### Comparative Example 3

Comparative Example 3 is the same as Example 1 except that the composition ratio of the synthesis solution for membrane formation is changed to aluminium nitrate nonahydrate:

$$trimesic acid : water = 17.5 : 1 : 15000.$$

### <X-Ray Diffraction Measurement of Separation Membrane Complex>

By X-ray Diffraction Measurement, measured is the diffraction pattern on the separation membrane surface in Examples 1 to 10 and Comparative Examples 1 to 3. From the X-ray diffraction pattern, it can be confirmed in Examples 1 to 10 and Comparative Examples 1 to 3 that the MIL-96 membrane is formed. Further, in Examples 1 to 10 and Comparative Example 3, in the X-ray diffraction pattern, the ratio of the peak intensity in the vicinity of 2θ=5.6° to the peak intensity in the vicinity of 2θ=9.0° (i.e., the peak intensity ratio of 5.6°/9.0° in Table 2) is not higher than 0.15 and the ratio of the peak intensity in the vicinity of 2θ=5.6° to the peak intensity in the vicinity of 2θ=16.6° (i.e., the peak intensity ratio of 5.6°/16.6° in Table 2) is not higher than 0.4. On the other hand, in Comparative Examples 1 and 2, the peak intensity ratio of 5.6°/9.0° is larger than 0.15, and the peak intensity ratio of 5.6°/16.6° is larger than 0.4. In Comparative Example 1, the c-axis oriented MIL-96 membrane is obtained, and in Comparative Example 2, the a- and b-axis-oriented MIL-96 membrane is obtained.

Further, for the X-ray diffraction measurement, an X-ray diffraction apparatus manufactured by Rigaku Corporation (apparatus name: MiniFlex 600) is used on the condition that the tube voltage is 40 kV, the tube current is 15 mA, the scanning speed is 0.5°/min, and the scanning step is 0.02°. Furthermore, other conditions are that the divergence slit is 1.25°, the scattering slit is 1.25°, the receiving slit is 0.3 mm, the incident solar slit is 5.0°, and the light-receiving solar slit is 5.0°. No monochromator is used, and as a CuKβ ray filter, used is a nickel foil having a thickness of 0.015 mm.

### <Permeance Measurement of Separation Membrane Complex>

On each of CO₂ gas and N₂ gas, the permeance of single gas is measured by using the above-described separation apparatus 2. Then, a ratio of the permeance of CO₂ gas to the permeance of N₂ gas (CO₂ permeance/N₂ permeance) is obtained as CO₂/N₂ ideal separation factor. In the separation membrane complex of each of Examples 1 to 10, the CO₂/N₂ ideal separation factor is not lower than 2, and the separation membrane complex has CO₂ selectivity. For example, in the separation membrane complex of Example 1, the CO₂/N₂ ideal separation factor is 2.2, and in the separation membrane complex of Example 10, the CO₂/N₂ ideal separation factor is 2.8. On the other hand, in the separation membrane complex of Comparative Example 1, the CO₂/N₂ ideal separation factor is 0.4, and in the separation membrane complex of Comparative Example 2, the CO₂/N₂ ideal separation factor is 0.8. In the separation membrane complex of Comparative Example 3, each of CO₂ gas and N₂ gas does not permeate the separation membrane complex, and the permeance thereof cannot be measured. In other words, in Comparative Example 3, the separation membrane is not substantially formed. Further, while the pH of the synthesis solution for membrane formation is in a range of 1.90 to 2.51 in Examples 1 to 10, the pH of the synthesis solution is out of the above-described range in Comparative Examples 1 to 3.

As described above, the separation membrane complex 1 includes the porous support 11 and the separation membrane 12 which is formed on the support 11 and composed of metal organic framework MIL-96. CO₂ gas can permeate the separation membrane complex 1. Further, in the X-ray diffraction pattern obtained by X-ray irradiation onto the surface of the separation membrane 12, the intensity of the peak existing in the vicinity of 2θ=5.6° is not higher than 0.15 times the intensity of the peak existing in the vicinity of 2θ=9.0° and not higher than 0.4 times the intensity of the peak existing in the vicinity of 2θ=16.6°. It is thereby possible to provide the separation membrane complex 1 having CO₂ selectivity and high CO₂/N₂ separation performance and appropriately separate and collect CO₂ by using the separation membrane complex 1.

Preferably, the CO₂/N₂ ideal separation factor in the separation membrane complex 1 is not lower than 2. It is thereby possible to efficiently separate and collect CO₂.

The method of producing the separation membrane complex 1 includes a step of depositing the seed crystals composed of the metal organic framework MIL-96 onto the porous support 11 and a step of forming the separation membrane 12 on the support 11 by immersing the support 11 in the synthesis solution which contains an Al source and trimesic acid and has a pH of 1.90 to 2.51 and performing the hydrothermal synthesis to grow the metal organic framework MIL-96 from the seed crystals. It is thereby possible to provide the separation membrane complex 1 having high CO₂/N₂ separation performance without using any additive such as N-Methylformamide, acetic acid, or the like.

Preferably, the average particle diameter of the seed crystals is 180 to 220 nm. Thus, by using the seed crystals having a relatively small average particle diameter, it becomes possible to form the separation membrane 12 at a synthesis temperature lower than the synthesis temperature shown in above-described Document 2 (see above-described Comparative Examples 1 and 2).

In the above-described separation membrane complex 1 and the above-described method of producing the separation membrane complex 1, various modifications can be made.

The separation membrane complex 1 may be produced by any method other than the above-described production method.

Only if the separation membrane complex in which the peak intensity ratio of 5.6°/9.0° is not higher than 0.15 and the peak intensity ratio of 5.6°/16.6° is not higher than 0.4 can be produced, the average particle diameter of the seed crystals may be smaller than 180 nm or may be larger than 220 nm.

The separation membrane complex 1 may further include a function layer or a protective layer laminated on the separation membrane 12, additionally to the support 11 and the separation membrane 12. Such a function layer or a protective layer may be an inorganic membrane such as a zeolite membrane, a silica membrane, a carbon membrane, or the like or an organic membrane such as a polyimide membrane, a silicone membrane, or the like. Further, a substance that is easy to adsorb a specific molecule such as CO₂ or the like may be added to the function layer or the protective layer laminated on the separation membrane 12.

In the separation apparatus 2 and the separation method, any substance other than the substances exemplarily shown in the above description may be separated from the mixed substance.

The configurations in the above-described preferred embodiment and variations may be combined as appropriate only if those do not conflict with one another.

While the invention has been shown and described in detail, the foregoing description is in all aspects illustrative and not restrictive. It is therefore understood that numerous modifications and variations can be devised without departing from the scope of the invention.

### INDUSTRIAL APPLICABILITY

The separation membrane complex of the present invention can be used in various fields as a separation membrane, an adsorption membrane, or the like for any of various substances other than CO₂.

### REFERENCE SIGNS LIST

1 Separation membrane complex
11 Support
12 Separation membrane
S11 to S14, S21, S22 Step

1. A separation membrane complex, comprising:
a porous support; and
a separation membrane which is formed on said support and composed of metal organic framework MIL-96,
wherein in an X-ray diffraction pattern obtained by X-ray irradiation onto a surface of said separation membrane, an intensity of a peak existing in vicinity of 2θ=5.6° is not higher than 0.15 times an intensity of a peak existing in vicinity of 2θ=9.0° and not higher than 0.4 times an intensity of a peak existing in vicinity of 2θ=16.6°.

2. The separation membrane complex according to claim 1, wherein CO₂/N₂ ideal separation factor is not lower than 2.

3. A method of producing a separation membrane complex, comprising:
a) depositing seed crystals composed of metal organic framework MIL-96 onto a porous support; and
b) forming a separation membrane on said support by immersing said support in a synthesis solution which contains an Al source and trimesic acid and has a pH of 1.90 to 2.51 and performing hydrothermal synthesis to grow metal organic framework MIL-96 from said seed crystals.

4. The method of producing a separation membrane complex according to claim 3, wherein
an average particle diameter of said seed crystals is 180 to 220 nm.
